(19) United States
(12) Patent Application Publication
(10) Pub. No.: US 2017/0105421 A1
(43) Pub. Date: Apr. 20, 2017

(54) Device to Prepare Turnovers

(71) Applicant: Alejandra Isabel Saldana, Austin, TX (US)

(72) Inventor: Alejandra Isabel Saldana, Austin, TX (US)

(21) Appl. No.: 15/229,428

(22) Filed: Aug. 5, 2016

Related U.S. Application Data
(63) Continuation-in-part of application No. 14/578,018, filed on Dec. 19, 2014.

(30) Foreign Application Priority Data
Jan. 19, 2016 (MX) MX/A/2016/000758

(51) Int. Cl. A21C 9/06; A21C 11/00

(52) U.S. Cl. CPC A21C 9/063; A21C 11/006

(57) ABSTRACT

Device for food processing that facilitate the user the food processing of turnovers in a fast way and as a result, saves time and energy in this kind of work, which is comprised of a base element with two parts that can be folded in an independent way. In addition, it is provided with a top contact element and a closing element type lever. Besides, all the products produced with this device will came out in identical shape and size.

There are some similar products on the market; however, this invention is a novelty product, since it has concave surfaces which allow the appropriate accommodation of the food to be prepared. In addition, it has a lever that makes sure that a similar quantity of the product is evenly distributed in each production cycle.

### BRIEF DESCRIPTION OF THE ILLUSTRATION

### Model 1

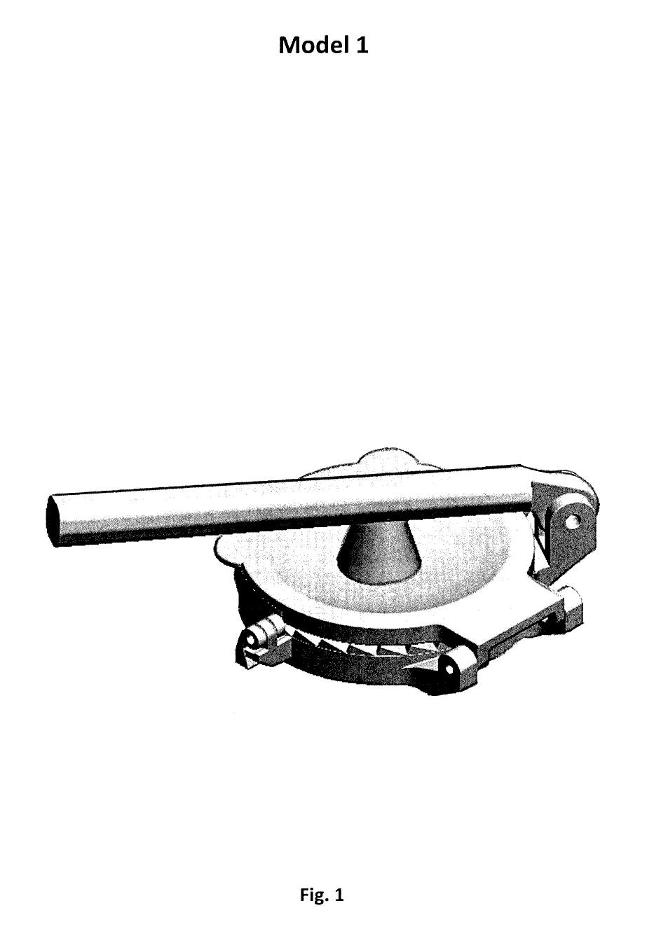

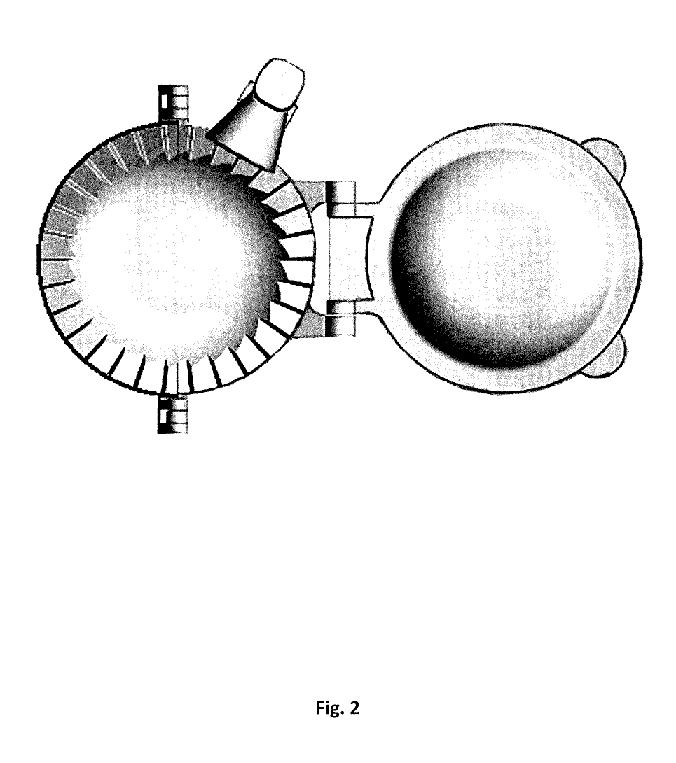

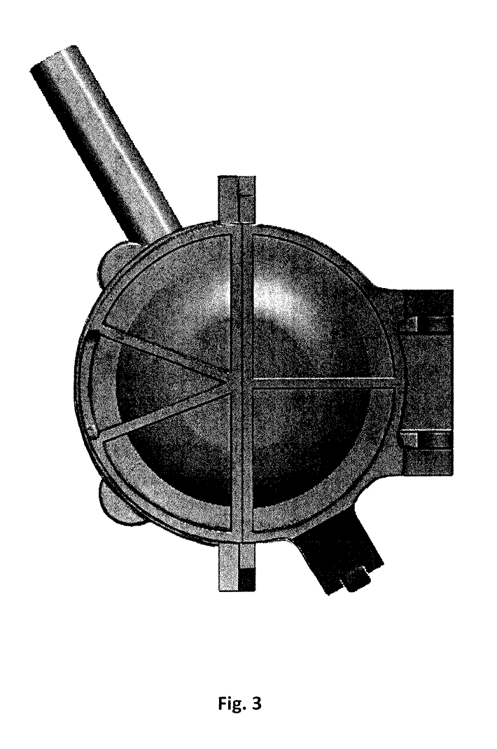

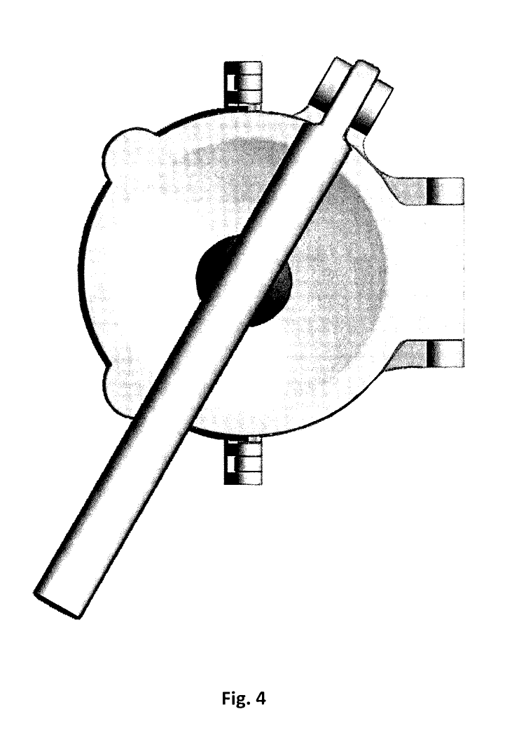

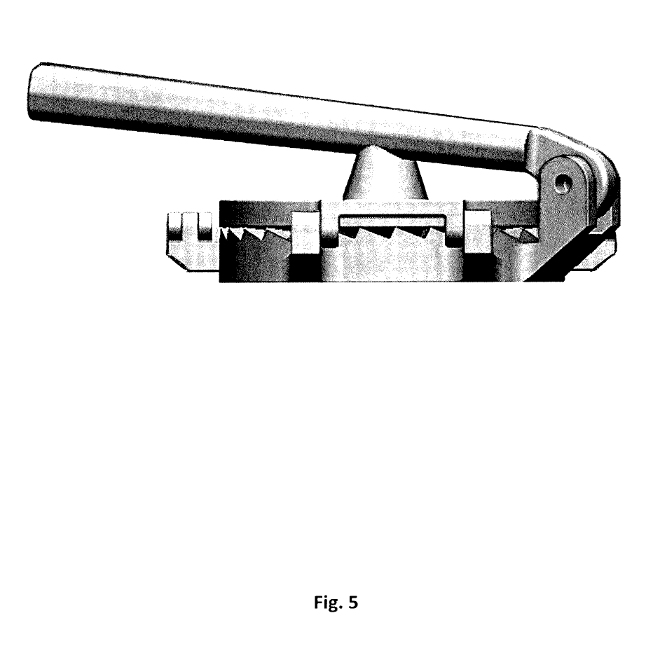

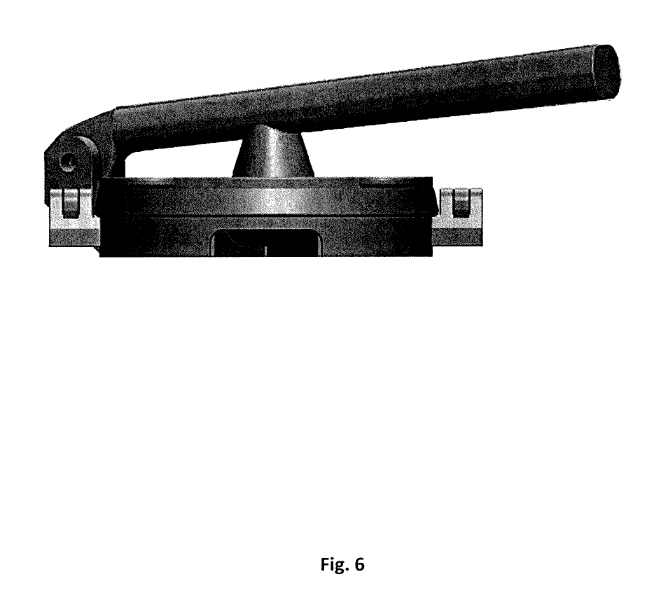

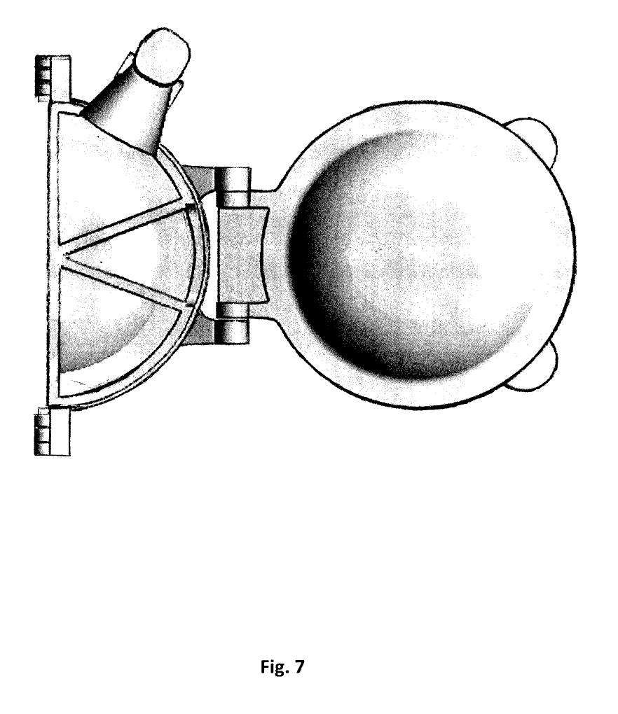

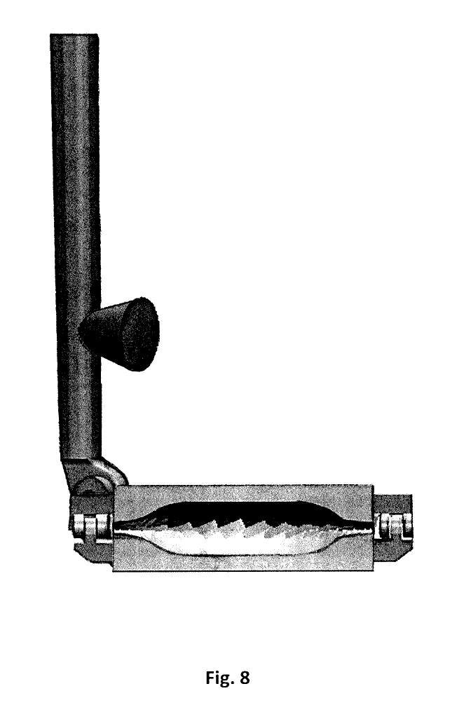

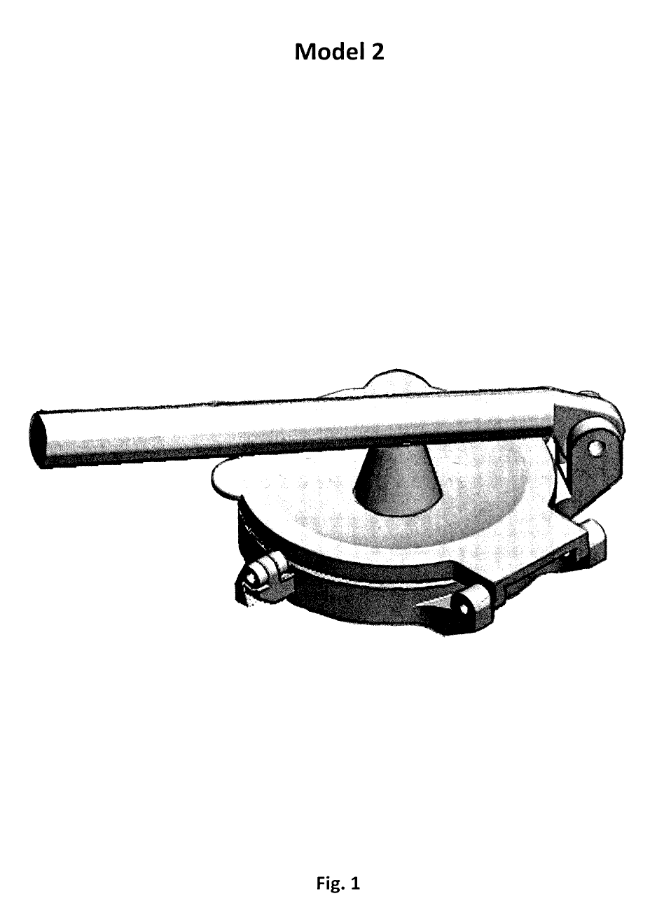

FIG. 1 shows a perspective view of the device to prepare turnovers in closed position.

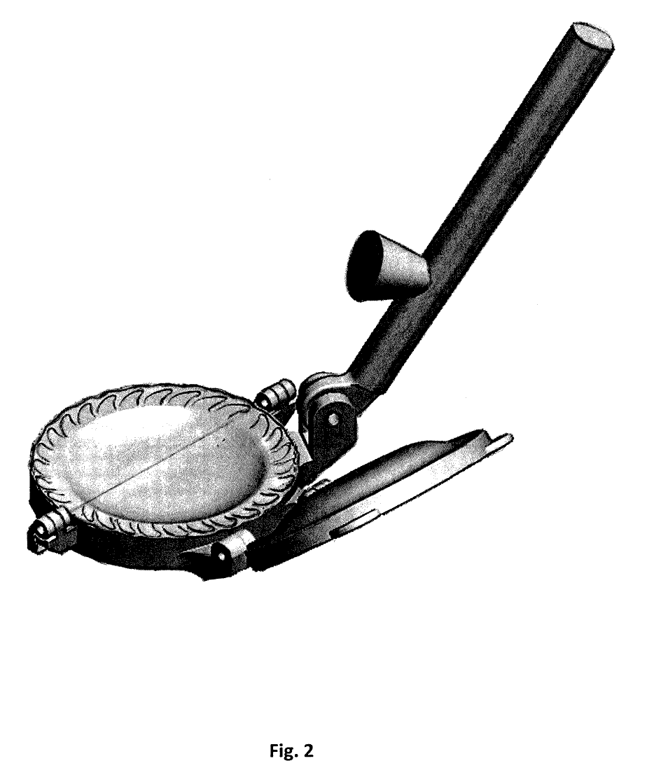

FIG. 2 shows a top view of the device to prepare turnovers in open position.

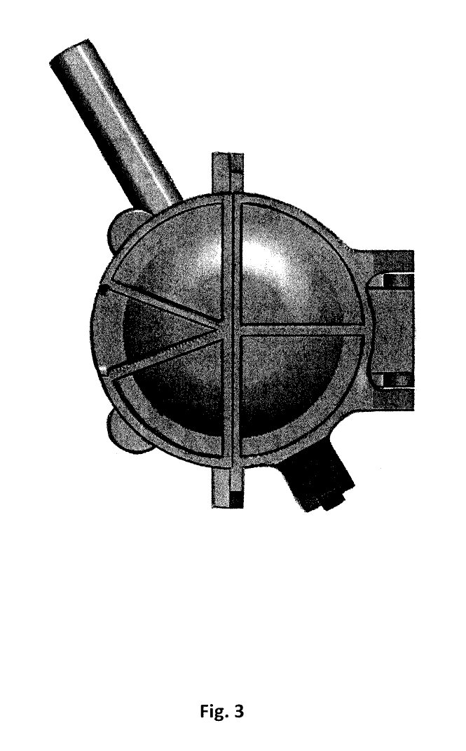

FIG. 3 shows a bottom view of the device to prepare turnovers.

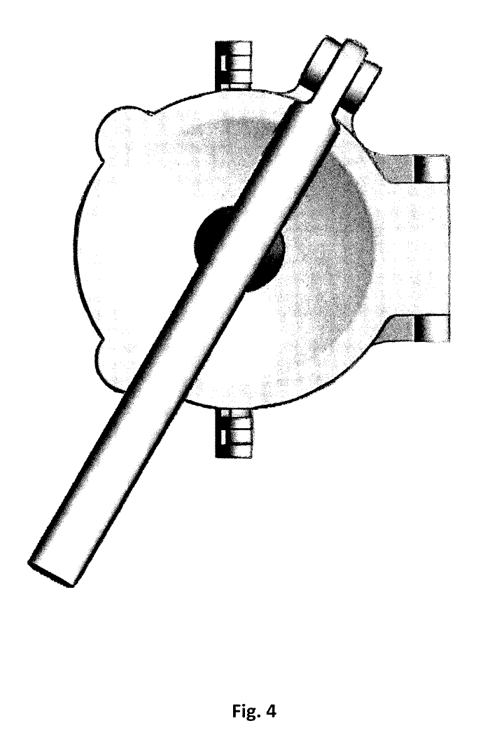

FIG. 4 shows a top view of the device to prepare turnovers in close position.

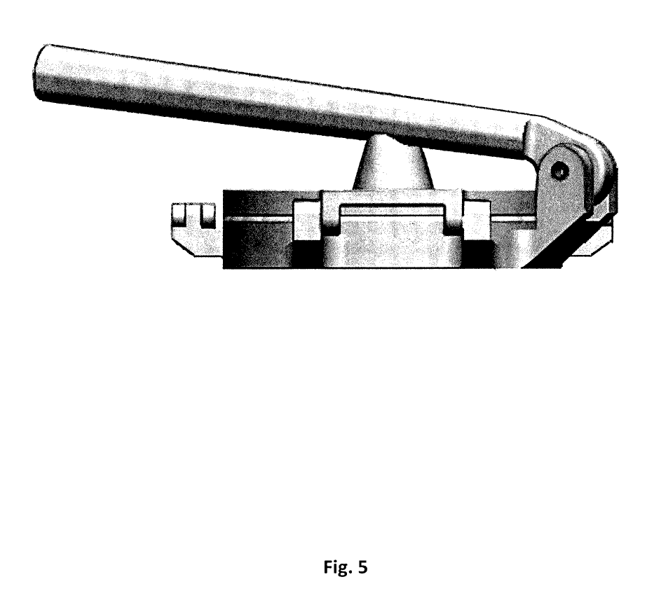

FIG. 5 shows a back view of the device to prepare turnovers.

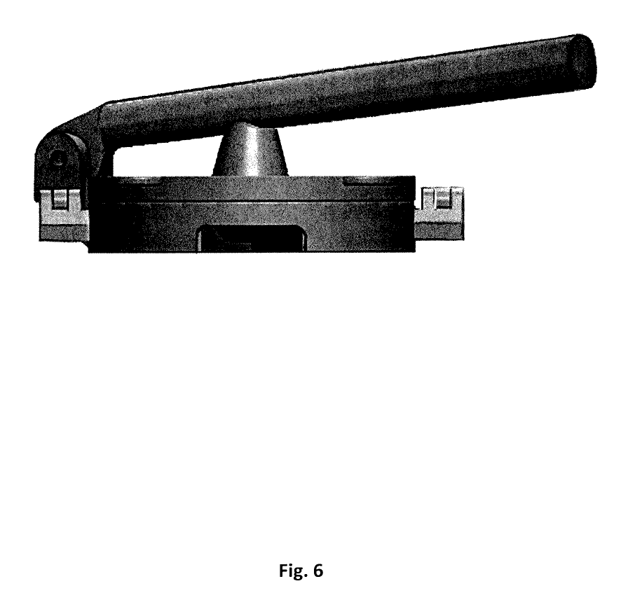

FIG. 6 shows a front view of the device to prepare turnovers.

FIG. 7 shows a top view of the device to prepare turnovers with the superior surface open and with the half of the folded base.

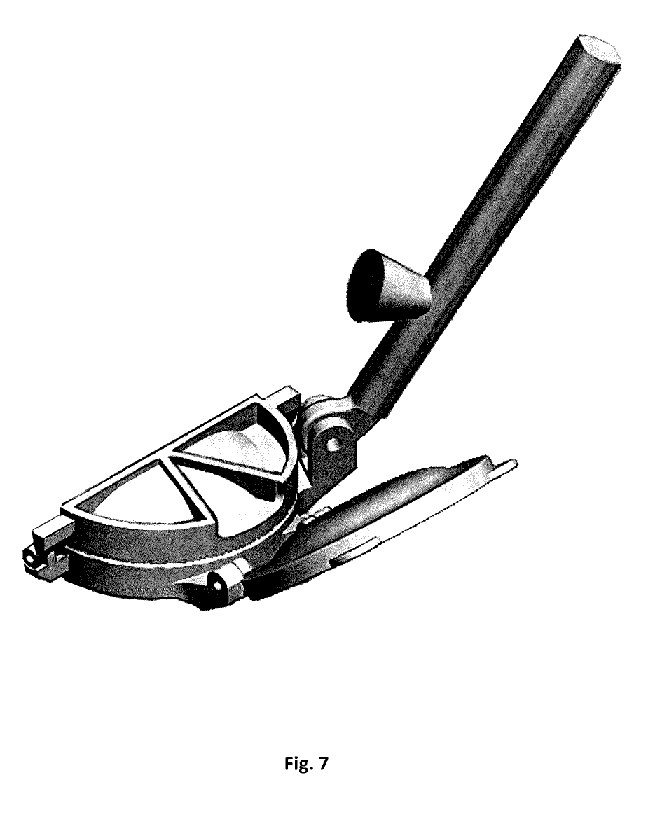

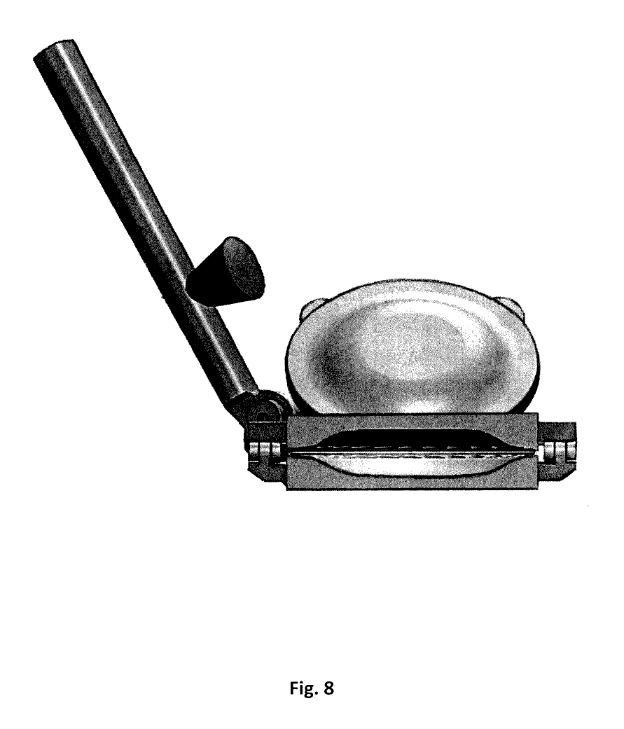

FIG. 8 shows a side view of the device to prepare turnovers with the half of the folded base.

### Model 2

FIG. 1 shows a perspective view of the device to prepare turnovers in closed position.

FIG. 2 shows a perspective view of the device to prepare turnovers in open position.

FIG. 3 shows a bottom view of the device to prepare turnovers.

FIG. 4 shows a top view of the device to prepare turnovers in close position.

FIG. 5 shows back view of the device to prepare turnovers in closed position.

FIG. 6 shows a front view of the device to prepare turnovers.

FIG. 7 shows a perspective view of the device to prepare turnovers in open position and with the half of the folded base.

FIG. 8 shows a side view of the device to prepare turnovers with the half of the folded base.

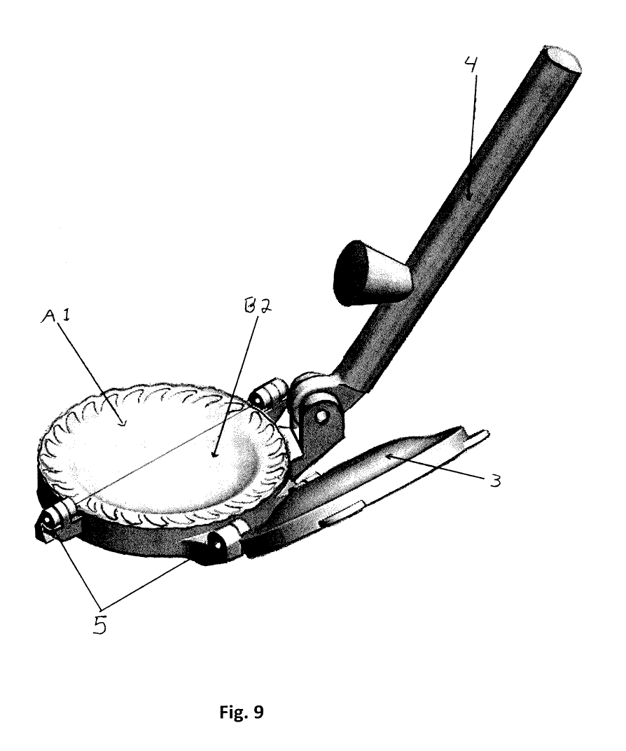

FIG. 9 shows a perspective view of the device to prepare turnovers in open position and with numbers that match the following description.

### DETAILED DESCRIPTION OF THE INVENTION

Device to prepare food that is composed of a base element of circular concave shape in its upper surface and with a pattern with gradual undulations on its periphery, (model 1) or with a leaves shaped design on its periphery (model 2), with a flat base on its lower surface and is divided in two parts, the part A (1) and the part B (2), which are joined by at least one element type hinge (5), that allows both parts to have a movement of opening and closing, besides with an opening in the part A (1) of the base element that facilitates the person to open and closed this part. It has a slight slope that have been added to the periphery of the base element of circular concave shape (part A and B) to cut the dough excess of the turnovers or an edge with a slight slope in the part A of the base element of circular concave shape to cut the excess of dough. In addition is provided with a top element (3) of circular concave shape in its lower and upper surface of one piece, which is attached to part B (2) by a means of fastening hinge type (5), which allows that this top element have a movement of opening and closing with regard to the base element. Additionally, it has a lever-type element (4), with an attached truncated cone which makes contact with the upper surface of the top element (3), joined by fastening hinge type (5), to the part B, this element when manipulated will make pressure and will ensure the perfect closure of the base and top elements.

For its operation it is a simple device of curved shape since in the contact surfaces both elements resemble two dishes overlapping, the base is divided into two halves, that eventually will doubled by the half to give shape to the food preferably turnovers.

Besides, all the periphery of the upper surface of the base element, has a design specially made to form the repulgo of the turnovers, the top has a smooth surface and is designed to press the dough and form the dough into a shape of concave tortilla that afterwards will be filled of various foods such as jam, meet and cheese among others and will fold to form the turnover.

This invention is preferable made of plastic, wood, aluminum and cast iron or it can be made of any suitable material.

The person who uses this device to make turnovers no longer will have to use 2 or 3 different devices, so this device for food processing solves the problem of lengthy time consumption for making turnovers.

This utensil can be used for domestic use and restaurant sector. The benefit that it provides to the user is that it saves time and effort in making the turnovers.

Having described enough my invention, I consider as a novelty, and therefore I claim as my exclusive property contained in the following clauses:

1. A device for food processing comprising a base element of a circular concave shape in its upper surface and with a pattern of gradual undulations in its periphery, with a flat base on its bottom surface and that is divided in two parts, the part A and the part B which are joined at least with one element type hinge, which allows both parts to have a movement of opening and closing, in addition, is provided with a top element of circular concave shape in its lower and upper surface of one peace, which is attached to part B by a means of fastening hinge which allows that this top element have a movement of opening and closing with regard to the base element, additionally it has a lever-type element, joined by an element of fastening hinge type to the part B, this element when manipulated ensures the perfect closure of the base and top elements.
A truncated cone shape element has been added to the lever to reinforce the pressure of the lever on the middle of the upper surface of the top element of circular concave shape.
An opening in the part A of the base element of circular concave shape facilitates the person to open and closed this part.
A leaves shaped design on the periphery of the upper surface of the base element.
A slight slope that have been added to the periphery of part A and B of the base element of circular concave shape to cut the dough excess of the turnovers or an edge with a slight slope in the part A of the base element of circular concave shape to cut the excess of dough.
